(19) United States
(12) Patent Application Publication
(10) Pub. No.: US 2019/0024267 A1
(43) Pub. Date: Jan. 24, 2019

(54) SENSING FABRIC

(71) Applicant: Far Eastern New Century Corporation, Taipei (TW)

(72) Inventors: Wei-Che Hung, Taipei (TW); Yu-Chun Wu, Taipei (TW); Hsin-Kai Lai, Taipei (TW)

(21) Appl. No.: 15/821,849

(22) Filed: Nov. 24, 2017

(30) Foreign Application Priority Data
Jul. 20, 2017 (TW) 106124257

(51) Int. Cl. D03D 1/00; A41D 31/00; B32B 5/02; B32B 27/12; B32B 25/10; B32B 3/26; B32B 7/02

(52) U.S. Cl. CPC D03D 1/0088; A41D 31/0011; B32B 5/024; B32B 27/12; B32B 25/10; B32B 2535/00; B32B 7/02; D10B 2101/20; D10B 2401/18; B32B 2307/202; B32B 2333/04; B32B 3/266

(57) ABSTRACT

A sensing fabric includes a first conductive textile layer, a second conductive textile layer, and an elastic layer. The elastic layer is disposed between the first conductive textile layer and the second conductive textile layer, and at least a cavity is defined by the elastic layer, the first conductive textile layer, and the second conductive textile layer. The first conductive textile layer may be electrically connected to the second conductive textile layer by deforming the cavity, and the volume of the cavity is reduced during the deformation of the cavity. The cavity includes at least a through hole and the through hole is not disposed between the adjacent cavities, and the cavity may be exposed to an environment through the through hole. The sensing fabric is light-weight, durable, robust, and able to pass the standard laundering test.

### BACKGROUND OF THE INVENTION

### 1. Field of the Invention

The present invention relates generally to a sensing fabric, and more particularly to a light-weight wearable sensing fabric.

### 2. Description of the Prior Art

Recently, there is a great demand for self-management (self-care) and long-distance health care.

In order to fulfill the needs of instantly monitoring the physiological information of human bodies, physiological sensing devices are adopted and incorporated in wearable clothing. In this way, the physiological sensing devices may be used to instantly monitor the physiological information of the wearers for exercise or residential care, and the demand for self-management can be fulfilled.

For conventional physiological sensing devices, clothing for a wearer may have at least a sensing region. During the movement of the wearer, the sensing region may be pressed or stretched, which causes the changes of the electrical resistance of the sensing region. Then, the transmitter further sends out the corresponding signal for a specific change of the electrical resistance to provide the wearer sufficient information. U.S. Pat. No. 6,642,467 discloses a sensing device made of two layers of conductive material which are separated by a resilient spacing component made of a thick solid foam (approximately 10 mm in thickness). Thus, when wearing such clothing incorporating the resilient spacing component, the wearer may feel uncomfortable because the resilient spacing component is too thick. Besides, when the force is not uniformly applied to the sensing device or not applied to the sensing device at an angle of 90 degrees, the two layers of conductive material may be displaced or loosened from each other. As a result, the two layers of conductive material may not be properly electrically connected to each other, and the structure of the sensing device may inevitably be damaged during the operation. Taiwan Patent Publication No. 201542187 discloses a physical activity sensing device including an elastic insulating body, an elastic conductive body, and a sensing body. The sensing body includes a liner and a conductive substrate, where the liner is made of solid foam with a thickness of 1 cm to 4 cm. The physical activity sensing device, however, is mainly incorporated in a mattress and is too thick to be used as a wearable sensing fabric. In addition, since the liner is not adhered to the conductive substrate but fixed to the conductive substrate by external molds, the liner may slide laterally when the force is not uniformly applied to the liner or not applied to the liner at a certain angle.

### SUMMARY OF THE INVENTION

To this end, a sensing fabric is provided to overcome the drawbacks of the conventional techniques.

According to one embodiment of the present invention, a sensing fabric includes a first conductive textile layer, a second conductive textile layer, and an elastic layer. The elastic layer is disposed between the first conductive textile layer and the second conductive textile layer, and at least a cavity is defined by the elastic layer, the first conductive textile layer, and the second conductive textile layer. The first conductive textile layer may be electrically connected to the second conductive textile layer by deforming the cavity, and the volume of the cavity is reduced during the deformation of the cavity. The cavity includes at least a through hole and the through hole is not disposed between the adjacent cavities, and the cavity may be exposed to an environment through the through hole.

The sensing fabric has a simple structure which can be fabricated easily. Also, misalignment may be prevented during the process of fabrication or operation of the sensing fabric. The sensing fabric is also a durable and robust sensing fabric which is able to pass the standard laundering test. Furthermore, the sensing fabric can be washed without being disassembled in advance, which is obviously superior to the conventional sensing device.

Besides, the sensing fabrics according to the embodiments of the present invention are light-weight and potentially useful in a wide variety of applications. When the sensing fabric is incorporated in clothing, the wearer may not feel uncomfortable or stiff because the sensing fabric is relatively light and soft. For instance, the sensing fabric may be incorporated in clothing near the wearer's elbows or knees so as to detect the movement of the elbows or knees to get information about movement frequency and variation of movement angle. Besides, the sensing fabric may also be incorporated in shoe pads to detect the force applied from the wearer's feet when the wearer stands or moves on the ground. In this way, the wearer's posture can be monitored by analyzing the data transmitted from the sensing fabric. Analogously, the sensing fabric may be incorporated in mattresses, carpets and so forth, so as to detect the posture of the people lying on the mattress or standing on the carpet.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

For more complete understanding of the present invention and its advantage, reference is now made to the following description, taken in conjunction with accompanying drawings, in which:

FIG. 1 is a schematic cross-sectional view of a wearable sensing fabric in accordance with one embodiment of the present invention;

FIG. 2A is a schematic cross-sectional view of a conductive textile layer in accordance with one embodiment of the present invention;

FIG. 2B is a schematic cross-sectional view of a conductive textile layer in accordance with another embodiment of the present invention;

FIG. 3A is a schematic perspective view of a wearable sensing fabric in accordance with one comparative embodiment of the present invention;

FIG. 3B is a schematic cross-sectional view of a wearable sensing fabric in accordance with one comparative embodiment of the present invention;

FIG. 4 is a schematic perspective view of a wearable sensing fabric in accordance with still another embodiment of the present invention; and

FIG. 5 is a schematic perspective view of a wearable sensing fabric in accordance with yet another embodiment of the present invention.

### DETAILED DESCRIPTION

In the following paragraph, various embodiments are disclosed with reference to the accompanying drawings. In addition, like or similar features will usually be described with same reference numerals for ease of illustration and description thereof.

While this invention is described with reference to illustrative embodiments to fully convey the scope of the invention to one of ordinary skill in the art, the description is not intended to be construed in a limiting sense. Various modifications and combinations of the illustrative embodiments, as well as other embodiments of the invention, will be apparent to one of ordinary skill in the art in light of this disclosure. It is intended that the scope of the invention is not limited by the detailed description, but rather by the claims appended hereto.

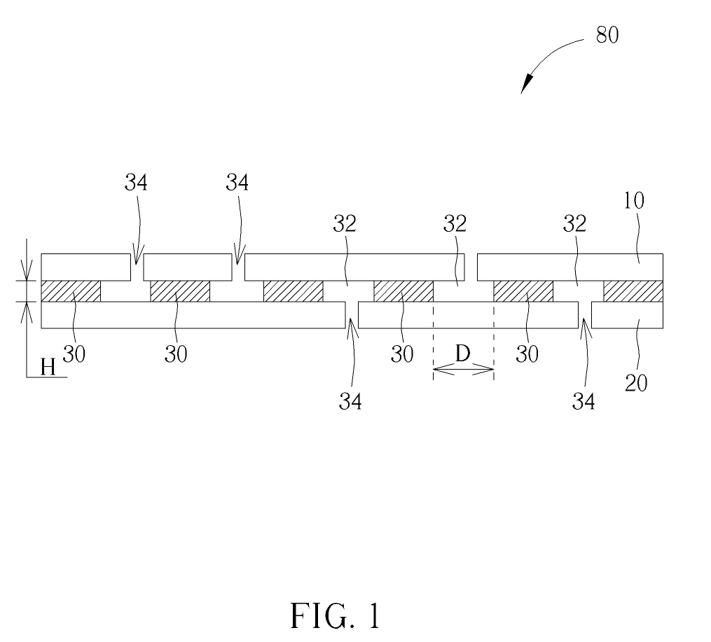

FIG. 1 is a schematic cross-sectional view of a wearable sensing fabric in accordance with one embodiment of the present invention. As shown in FIG. 1, a sensing fabric 80 includes a first conductive textile layer 10, a second conductive textile layer 20, and an elastic layer 30 disposed between the first conductive textile layer 10 and the second conductive textile layer 20. At least a cavity 32 is defined by the elastic layer 30, the first conductive textile layer 10, and the second conductive textile layer 20. Since the volume of the cavity 32 is reduced during the deformation of the cavity 30, the first conductive textile layer 10 may be electrically connected to the second conductive textile layer 20 by deforming the cavity 32. The cavity 32 includes at least a through hole 34 and the through hole 34 not disposed between the adjacent cavities 32, and the cavity 32 may be exposed to an environment through the through hole 34.

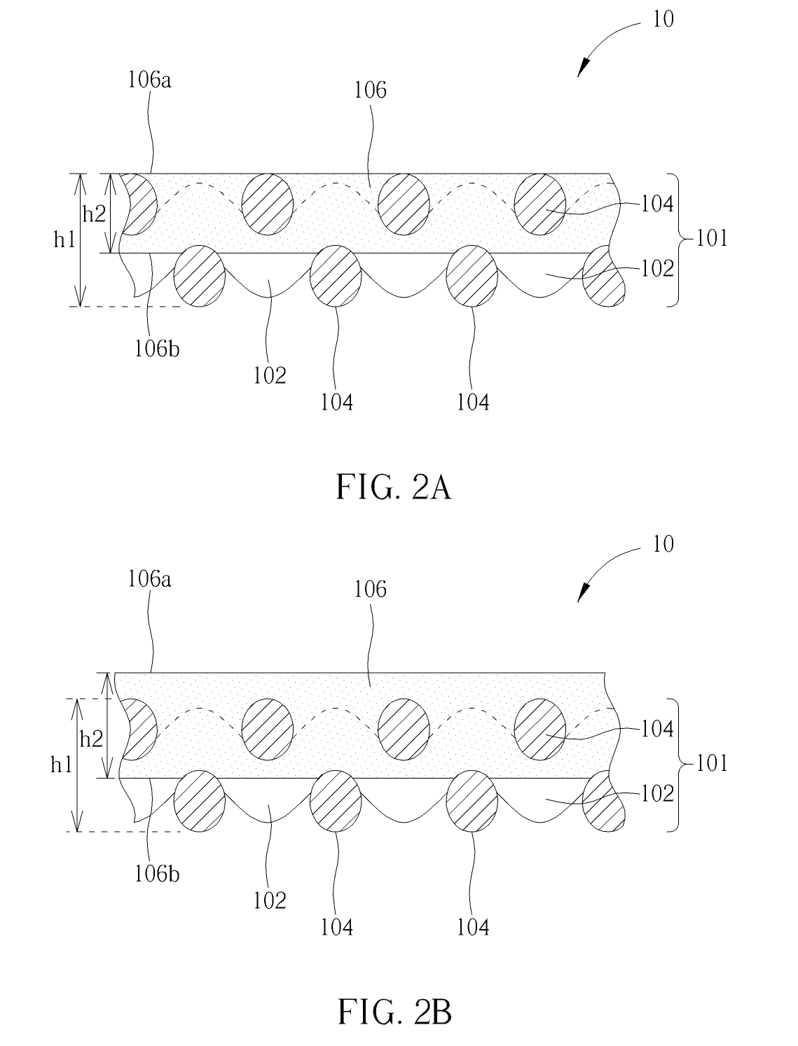

FIG. 2A is a schematic cross-sectional view of a conductive textile layer in accordance with one embodiment of the present invention. Please refer to FIG. 2A, a first conductive textile layer 10 includes a fabric substrate 101 and a conductive coating layer 106 embedded in one side of the fabric substrate 101. In this embodiment, the fabric substrate 101 is a weaving fabric (e.g. plain weaving fabric) made of several interlaced weft threads 102 and warp threads 104. Thus, the fabric substrate 101 made of interlaced threads has a thickness h1. The conductive coating layer 106 is embedded in the fabric substrate 101 from one side of the fabric substrate 101 to become an integral structure, and the space among the interlaced threads may be filled up by the conductive coating layer 106.

In this embodiment, the conductive coating layer 106 is completely merged and embedded in the fabric substrate 101. The upper side 106a of the conductive coating layer 106 is coplanar with the upper side of the fabric substrate 101, and the lower side 106b of the conductive coating layer 106 is inside the fabric substrate 101. As a result, the contour of the conductive coating layer 106 is substantially leveled with the upper side of the fabric substrate 101. In this embodiment, the thickness h2 of the conductive coating layer 106 is not larger than the thickness h1 of the fabric substrate 101.

FIG. 2B is a schematic cross-sectional view of a conductive textile layer in accordance with another embodiment of the present invention. In this embodiment, a first conductive textile layer 10 also includes a fabric substrate 101 and a conductive coating layer 106 embedded in one side of the fabric substrate 101. The main difference between the present embodiment and the previous embodiment is that the conductive coating layer 106 in the present embodiment is partially embedded in the fabric substrate 101, which means portions of the conductive coating layer 106 may protrude from the upper side of the fabric substrate 101. In other words, the upper side 106a of the conductive coating layer 106 is higher than the upper side of the fabric substrate 101, while the lower side 106b of the conductive coating layer 106 is still in the fabric substrate 101.

The thickness of the conductive coating layer 106 protruding out of the fabric substrate 101 is not limited to a certain range. However, for the sake of comfort when the first conductive textile layer 10 contacts the wearer's skin, the protruding portion of the conductive coating layer 106 has a thickness of preferably not greater than 40 μm, more preferably not greater than 30 μm, and much more preferably not greater than 20 μm.

The previously described fabric substrate 101 is made by weaving. However, one of ordinary skill in the art based on the instant disclosure would understand that the fabric substrate 101 may be made by knitting. It is, however, preferably to use weaving fabric as the fabric substrate 101 since the weaving fabric has relatively high structural strength and is thinner than that of the knitted fabric. The types and forms of the weaving fabric in the instant disclosure are not limited as long as the conductive coating layer 106 can be embedded in the fabric and the mechanical strength of the first conductive textile layer 10 can be kept at a certain level.

The conductive coating layer 106 is made of a hydrophobic adhesive and a plurality of conductive particles distributed in the hydrophobic adhesive. The hydrophobic adhesive applicable in the instant disclosure is selected from the group consisting of polyurethane (PU), silicone resin, polyethylene terephthalate (PET), polyacrylate and the like, but not limited thereto. The conductive particles applicable in the instant disclosure include non-metal materials, metal materials or the combination thereof. The non-metal materials include, but not limited to, carbon nanotubes (CNT), carbon black, carbon fiber, graphene and conductive polymers (e.g. poly(3,4-ethylenedioxythiophene) (PEDOT), polyacrylonitrile (PAN) and the like). Carbon nanotubes provide the most preferably result. The metal materials include, but not limited to, gold, silver, copper, and metal oxide (e.g. indium tin oxide (ITO)) and the like.

The conductive coating layer 106 can be embedded in the fabric substrate 101 by any known approaches. For example, the hydrophobic adhesive is dissolved in a solvent, and then the conductive particles are distributed in the solution to form a conductive coating solution. Subsequently, the conductive coating solution is coated on the fabric substrate 101 and immersed into the fabric substrate 101 to form a conductive coating layer. Finally, the conductive coating layer is dried completely so as to obtain a first conductive textile layer 10.

The coating method in the instant disclosure is not limited to a certain approach. However, in order to achieve an uniform and flat surface, the coating method may adopt conventional printing approaches including, for example, gravure printing, screen printing, relief printing, slot coating, and so forth, but not limited thereto. Alternatively, the conductive coating solution may be applied to a piece of release paper to form a conductive coating layer followed by being partially dried. Subsequently, the conductive coating layer is adhered to a fabric substrate 101 by a roller when it is not completely dried. Afterwards, the release paper is peeled off, and then the conductive coating layer 106 is completely dried. As a result, a first conductive textile layer 10 is obtained.

According to some embodiments of the present invention, the structure and the fabrication process of the second conductive textile layer 20 may be similar to those of the first conductive textile layer 10. Besides, one of ordinary skill in the art would understand the structure and the fabrication process may be modified in order to meet various design or fabrication requirements.

The elastic layer 30 according to this embodiment is used to physically and electrically separate the first conductive textile layer 10 from the second conductive textile layer 20. In addition, the side coated with the conductive coating layer of the first conductive textile layer 10 may face that of the second conductive textile layer 20. Holes may be formed in the elastic layer 30 and sandwiched between the first conductive textile layer 10 and the second conductive textile layer 20. Therefore, the holes may become cavities 32 when the elastic layer 30 is sandwiched by the conductive textile layers 10 and 20.

The space of the cavities 32 may substantially separate the first conductive textile layer 10 from the second conductive textile layer 20 when there is no external force is applied to the conductive textile layers. When an external force is applied and strong enough to deform and reduce the volume of the cavities 32, the first conductive textile layer 10 may thus be electrically connected to the second conductive textile layer 20.

In other words, the thickness of the elastic layer 30 is the height H of the cavity 32. In order to prevent the issue of misalignment and fulfill the demand for thin fabric, the height H of the cavity 32 is preferably greater than 0.1 mm and less than or equal to 2 mm.

In a case where the height H of the cavity 32 is less than 0.1 mm (i.e. the thickness of the elastic layer 30 is less than 0.1 mm), the elastic layer 30 may not be thick enough to separate the first conductive textile layer 10 from the second conductive textile layer 20. In other words, the first conductive textile layer 10 may be electrically connected to the second conductive textile layer 20 even if there is no external force applied to the sensing fabric 80, which thus deteriorates the sensibility of the sensing fabric 80. In another case where the height H of the cavity 32 is greater than 2 mm (i.e. the thickness of the elastic layer 30 is greater than 2 mm), the entire thickness of the sensing fabric 80 would be too thick, which may make the wearer putting on the sensing fabric 80 feel uncomfortable and also reduce the sensibility of the sensing fabric 80.

Besides, the space of the cavities 32 has to be large enough so as to separate the first conductive textile layer 10 from the second conductive textile layer 20. In accordance with the embodiments of the present invention, a diameter-to-height ratio, i.e. the longest distance (D) between two points on the peripheral of each cavity 32 when viewed from a top-down perspective divided by the height (H) of each cavity 32, is measured to determine whether the first conductive textile layer 10 can be effectively separated from the second conductive textile layer 20 by the cavities 32.

When the diameter-to-height ratio of each cavity 32 is too low, i.e. the space of the cavity 32 is very narrow, it is hard for the first conductive textile layer 10 to be electrically connected to the second conductive textile layer 20 even if there is an external force applied to the sensing fabric 80. In other words, the sensing fabric 80 may not operate effectively. When the diameter-to-height ratio of each cavity 32 is too high, the first conductive textile layer 10 may easily hang down on the second conductive textile layer 20 even when there is no force applied to the sensing fabric 80. In other words, the space of the cavity 32 cannot separate the first conductive textile layer 10 from the second conductive textile layer 20 effectively, which deteriorates the sensitivity of the sensing fabric 80.

Preferably, the diameter-to-height ratio of the cavity in accordance with the embodiments of the present invention is 5-80, and more preferably 5-35.

The ratio of the entire area of cavities 32 to the area of the sensing fabric 80 may also affect the sensitivity of the sensing fabric 80. A cavity rate may be calculated by dividing the sum of each area of the cavities 32 to the entire area of the sensing fabric 80 when viewed from a top-down perspective. In a case where several circular holes are formed in the elastic layer 30, and the cavities 32 are sandwiched between the first conductive textile layer 10 and the second conductive textile layer 20, the cavity rate is calculated as follows:

cavity rate=(n×π(D/2)²/total area of a sensing fabric)×100%

where

n is the number of the circular holes,

D is the diameter of each circular hole.

Preferably, the cavity rate in the sensing fabric in accordance with the embodiments of the present invention is 10%-60%, and more preferably 12%-55%.

When the cavity rate is relatively low, i.e. the number of the cavities 32 is too low or the total areas of the cavities 32 are too small, the first conductive textile layer 10 may not contact the second conductive textile layer 20 even when an external force is applied to the sensing fabric 80. Therefore, the sensing fabric 80 may be unsuitable for detecting the movement of the wearer effectively. When the cavity rate of the sensing fabric is relatively high, i.e. the number of the cavities 32 is too high or the total areas of the cavities 32 are too large, the first conductive textile layer 10 may easily hang down on the second conductive textile layer 20 even when there is no external force applied to the sensing fabric 80. That is because the proportion the elastic layer 30 in the sensing fabric 80 is too low to support the weight of the first conductive textile layer 10. As a result, there is often no obvious change in the resistance before and after applying the external force to the sensing fabric. Therefore, the sensing fabrics 80 may be unsuitable for detecting the movement of the wearer effectively.

The holes formed in the elastic layer 30 may be fabricated by mechanical cutting or laser cutting, but not limited thereto.

The shape of each hole formed in the elastic layer 30 when viewed from the top may be circle, rectangle, triangle, hexagon, and so forth, but not limited thereto.

The elastic layer 30 may include polyurethane, thermoplastic polyurethane (TPU), thermoplastic polyester elastomer (TPEE), polyethylene, ethylene vinyl acetate (EVA), polyvinyl chloride (PVC), silicone or natural rubber. Preferably, the elastic layer 30 is TPEE.

One of ordinary skill in the art would understand that the elastic layer 30 with the holes may be adhered to the first conductive textile layer 10 and the second conductive textile layer 20 in any appropriate approaches. Preferably, the elastic layer 30 may be adhered to the conductive textile layers by thermoforming. In particular, the elastic layer 30 may be uniformly adhered to the conductive textile layers, and the adhesion of the elastic layer 30 may be increased during the heating process. Therefore, the sensing fabric 80 may become softer and no misalignment would occur when the thermoforming process is conducted.

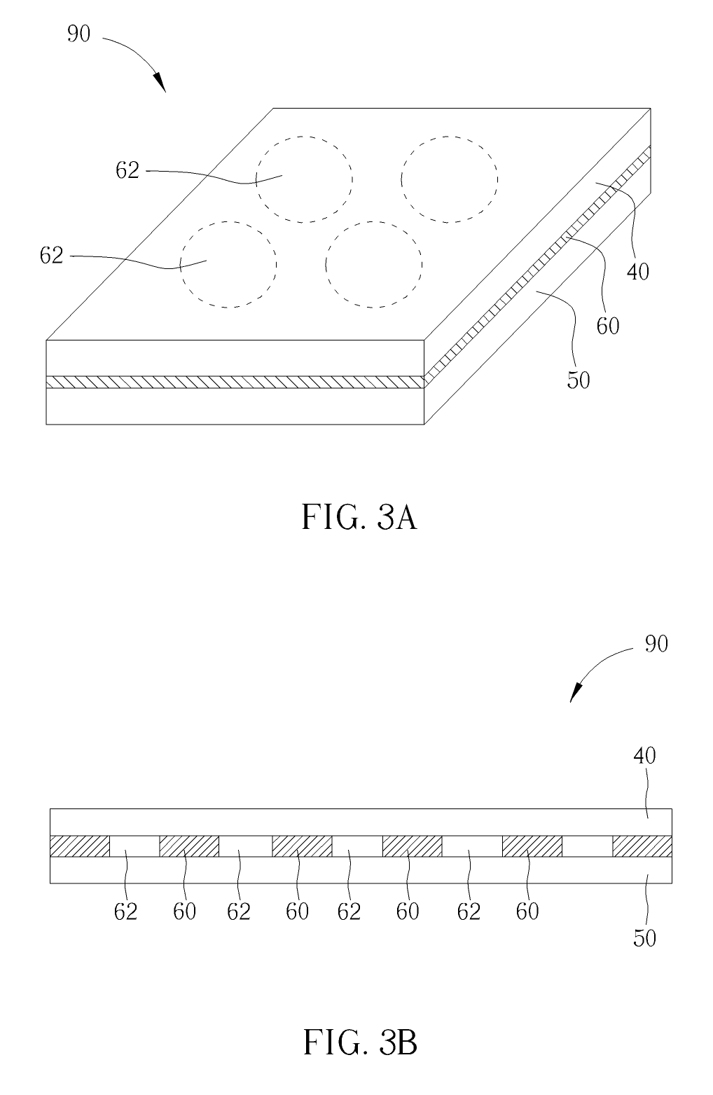

FIG. 3A is a schematic perspective view of a wearable sensing fabric in accordance with one comparative embodiment of the present invention. FIG. 3B is a schematic cross-sectional view of a wearable sensing fabric in accordance with one comparative embodiment of the present invention. A sensing fabric 90 includes a first conductive textile layer 40, a second conductive textile layer 50 and an elastic layer 60 having cavities 62 therein. The main difference between the comparative embodiment and the embodiment above is that the cavities 62 in the comparative embodiment do not have any through holes. Thus, when an external force is applied to the sensing fabric 90, the air in the cavities 62 can be vented only through micropores of the conductive textile layers. In other words, the external force has to be strong enough in order to deform the cavities and electrically connect two conductive textile layers. When the external force is removed, it is hard for the air outside the sensing fabric 90 to fill back into the cavities 62 in a short time since the micropores of the conductive textile layers are too small to make the air pass through quickly. Before next external force is applied, the space of the cavities 62 may not restore completely due to the lack of air filled in the cavities 62. That is, the first conductive textile layer 40 and the second conductive textile layer 50 may be electrically connected to each other even when the external force is removed. As a result, the sensitivity of the sensing fabric 90 is relatively low, which means that the sensing fabric 90 is unsuitable for monitoring the quick and intensive movement.

The through holes 34 in accordance of the embodiments of the present invention may be disposed in the first conductive textile layer 10, the second conductive textile layer 20 and/or the elastic layer 30. These embodiments are disclosed as follows.

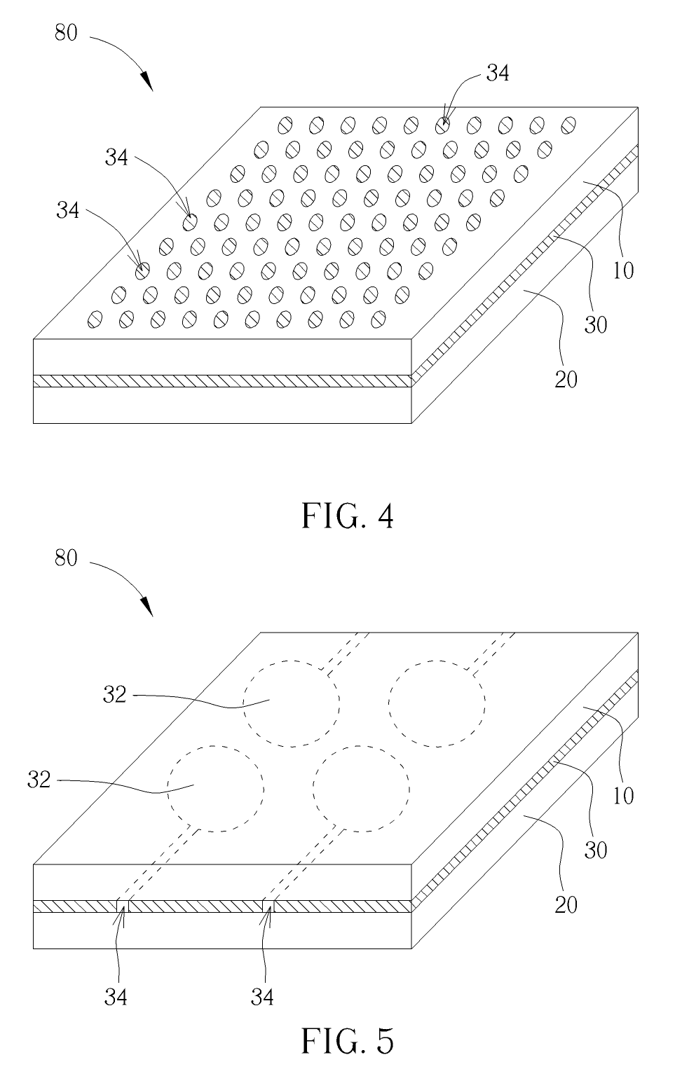

FIG. 4 is a schematic perspective view of a wearable sensing fabric in accordance with still another embodiment of the present invention. Each cavity 32 of a sensing fabric 80 includes at least a through hole 34 exposed to an environment and disposed in the first conductive textile layer 10. When an external force is applied to the sensing fabric 80, the cavities 32 may be deformed, which causes the volume of the cavities 32 to be reduced and the air in the cavities 32 to vent out in a short time. The first conductive textile layer 10 may be electrically connected to the second conductive textile layer 20 due to the force applied to the sensing fabric 80. When the external force is removed, the air outside the sensing fabric 80 may fill back into the cavities 32 through the through holes 34 quickly. As a result, the space of cavities 32 may recover before next movement, and the first conductive textile layer 10 may be electrically separated from the second conductive textile layer 20. Therefore, the sensing fabric 80 is suitable for operating quickly and repeatedly during a short period of time.

FIG. 5 is a schematic perspective view of a wearable sensing fabric in accordance with yet another embodiment of the present invention. Each cavity 32 of a sensing fabric 80 includes at least a through hole 34 disposed in the elastic layer 30 and exposed to an environment. When an external force is applied to the sensing fabric 80, the cavities 32 may be deformed, which causes the volume of the cavities 32 to be reduced and the air in the cavities 32 to vent out in a short time. The first conductive textile layer 10 may be electrically connected to the second conductive textile layer 20 due to the force applied to the sensing fabric 80. When the external force is removed, the air outside the sensing fabric 80 may fill back into the cavities 32 through the through holes 34 quickly. As a result, the space of the cavities 32 may recover before next movement, and the first conductive textile layer 10 may be electrically separated from the second conductive textile layer 20. Therefore, the sensing fabric 80 is suitable for operating quickly and repeatedly in a short period of time.

Thus, the size and the number of the through holes 34 is highly relevant to the resiliency of the cavity 32. The resiliency of the cavity 32 may be judged by the rate of the entire cross-sectional areas of the through holes 34 to the entire surface areas of the inner sidewalls of the cavities 32 (also called through-hole occupying rate).

When the through-hole occupying rate is too low, e.g. the through holes are too small or the number of the through holes is few, the air outside the sensing fabric may not fill back into the cavity 32 quickly, which means that the space of the cavity 32 cannot restore immediately. As a result, the sensing fabric is unsuitable for operating quickly and repeatedly during a short period of time. On the other hand, when the through-hole occupying rate is too high, the mechanical strength and the sensitivity of the sensing fabric 80 may also be deteriorated.

Preferably, the through-hole occupying rate in accordance of the embodiments of the present invention is 0.4-5%, and more preferably 0.45-5%, and even more preferably 1.5-2.5%.

The through holes 34 formed in the conductive textile layers and above the elastic layer 30 may be fabricated by mechanical cutting or laser cutting, but not limited thereto.

The shape of each through hole 34 when viewed from the top may be circle, rectangle, triangle, hexagon, and so forth, but not limited thereto.

The sensing fabric 80 in accordance with embodiments of the present invention may be used to detect the movement of the wearer or the force distribution from the person standing on the ground or lying on a bed. Therefore, the size of the sensing fabric is not limited and may be adjusted to fulfill different requirements.

Several examples are disclosed in the following paragraphs to further elaborate the present invention. The examples, however, is disclosed for the purpose of illustration, and the scope of the invention should not be limited by the examples but rather by the claims appended hereto.

### Chemicals and Equipment

Chemicals and equipment used in the following examples are described below:
1. polyurethane: CD-5030, solid content 30 wt % and n-Butyl acetate (nBAC) as solvent, Yamaken
2. carbon nanotubes: multi-walled carbon nanotube-01, Emaxwin tech
3. elastic layer: TPU95A, XianDar material tech
4. screen: Tetoron, ChiLong
5. laser cutting machine: HE-9060, Hongwei
6. thermal laminator: HA-860A, Jiin Yang
7. multimeter: DM2630, HILA
8. plain weave: 30-denier plain weave, Everest textile

### Fabricating Conductive Textile Layer

1 wt. part of carbon nanotube was added to and blended with 5 wt. parts of polyurethane coating solution so as to obtain a conductive coating solution. The conductive coating solution was then printed on a commercially available plain weave by a 200 mesh screen. Afterwards, the coated plain weave was dried by hot air at 150° C. to remove the solvent inside. As a result, a conductive textile layer including the plain weave and the conductive coating layer embedded in the plain weave fabric was obtained.

### Example 1

A sensing fabric was prepared in the following steps:

1. An elastic layer with a size of 2.5 cm (length)×2.5 cm (width)×0.3 mm (thickness) was cut by a laser cutting machine to form four circular holes with diameters of 10 mm equitably in the elastic layer.

2. A first conductive textile layer was cut by a laser cutting machine to form several through holes with a diameter of 1 mm in the first conductive textile layer. The distance between the centers of two adjacent through holes was 4 mm.

3. A second conductive textile layer with a conductive coating layer was adhered to the elastic layer with the circular holes by a thermal laminator at a pressure of 3 kg/cm². In this case, the conductive coating layer might face the elastic layer.

4. The second conductive textile layer incorporating the elastic layer obtained in step 3 was adhered to the first conductive textile layer with the through holes obtained in step 2 by a thermal laminator at a pressure of 3 kg/cm², where the conductive coating layer of the first conductive textile layer might face the elastic layer. A sensing fabric fabricated in this step might have cavities defined between the elastic layer, the first conductive textile layer, and the second conductive textile layer. A diameter-to-height ratio of each cavity was 33.3, a cavity rate was 50.3%, and a through-hole occupying rate was 2.36%. In this case, each cavity corresponds to 5 through holes. The diameter-to-height ratio, the cavity rate, and the through-hole occupying rate were calculated in the following equations:

diameter-to-height ratio=10/0.3=33.3

cavity rate=4×π×(10/2)²/(25×25)×100%=50.3%

through-hole occupying rate=(5×π×(½)₂)/(2×π×(10/2)²+π×10×0.3)×100%=2.36%

5. A solid foam with a size of 10 cm×10 cm×1 cm was put on a platform. Then, the sensing fabric obtained in step 4 was put on the solid foam, and the first conductive textile layer and the second conductive textile layer of the sensing fabric were respectively electrically connected to a positive and a negative electrode of a multimeter. Subsequently, the resistance of the sensing fabric was measured after a circular PMMA plate with a radius of 1 cm (2 g in weight) was put on the sensing fabric. Then, the resistance of the sensing fabric was measured again after a 800-gram weight was put on the center of the circular PMMA plate on the sensing fabric. The data was collected and shown in Table 1.

### Example 2

A sensing fabric (Example 2) was prepared as described above in Example 1, except that the thickness of the elastic layer was increased to 0.5 mm. The sensing fabric of Example 2 had a diameter-to-height ratio of 20 and a through-hole occupying rate of 2.27%. The sensing fabric was tested by the step similar to step 5 of Example 1, and the data was collected and shown in Table 1 below.

TABLE 1

| | Cavity | Resistance | Resistance | Diameter- |
|---|---|---|---|---|
| | Rate | without Load | with | to-Height |
| Example | (%) | (Ω) | Load (Ω) | Ratio |
| 1 | 50.3 | 18215 | 483 | 33.3 |
| 2 | 50.3 | 23127 | 526 | 20 |

As shown in Table 1, in a case where the sensing fabric (Example 1) is not loaded with the weight, the resistance of the sensing fabric is 18,215Ω. The reason is that the first conductive textile layer and the second conductive textile layer are separated by the cavity and thus are electrically isolated from each other. However, when the weight is put on the sensing fabric (Example 1), the resistance of the sensing fabric is down to 483Ω, which demonstrates that the first conductive textile layer is electrically connected to the second conductive textile layer at this time. For the sensing fabric (Example 2), where the diameter-to-height ratio of the cavity is different from that in sensing fabric (Example 1), when the sensing fabric (Example 2) is not loaded with the weight, the resistance of the sensing fabric is greater than 20,000Ω. However, when the weight is put on the sensing fabric (Example 2), the resistance of the sensing fabric is down to 526Ω, which demonstrates that the first conductive textile layer is electrically connected to the second conductive textile layer at this time.

### Example 3

A sensing fabric (Example 3) was prepared as described above in Example 1, except that step 1 described in Example 1 is replaced with the following step:

An elastic layer with a size of 12.5 cm (length)×12.5 cm (width)×0.2 mm (thickness) was cut by a laser cutting machine to form 25 circular holes with diameters of 10 mm in the elastic layer. The cavity of the sensing fabric in Example 3 had a diameter-to-height ratio of 50 and a through-hole occupying rate of 2.40%. The sensing fabric was tested by the step similar to step 5 of Example 1, and the data was collected and shown in Table 2 below.

### Example 4

A sensing fabric (Example 4) was prepared as described above in Example 1, except that step 1 described in Example 1 is replaced with the following step:

An elastic layer with a size of 7.5 cm (length)×7.5 cm (width)×0.33 mm (thickness) was cut by a laser cutting machine to form 9 circular holes with diameters of 10 mm in the elastic layer. The cavity of the sensing fabric in Example 4 had a diameter-to-height ratio of 30.3 and a through-hole occupying rate of 2.35%. The sensing fabric was tested by the step similar to step 5 of Example 1, and the data was collected and shown in Table 2 below.

### Example 5

A sensing fabric (Example 5) was prepared as described above in Example 1, except that step 1 described in Example 1 is replaced with the following step:

An elastic layer with a size of 2.5 cm (length)×2.5 cm (width)×1 mm (thickness) was cut by a laser cutting machine to form 1 circular hole with diameter of 10 mm in the elastic layer. The cavity of the sensing fabric in Example 5 had a diameter-to-height ratio of 10 and a through-hole occupying rate of 2.08%. The sensing fabric was tested by the step similar to step 5 of Example 1, and the data was collected and shown in Table 2 below.

### Example 6

A sensing fabric (Example 6) was prepared as described above in Example 1, except that step 1 described in Example 1 is replaced with the following step:

An elastic layer with a size of 2.5 cm (length)×2.5 cm (width)×2 mm (thickness) was cut by a laser cutting machine to form 1 circular hole with diameter of 10 mm in the elastic layer. The cavity of the sensing fabric in Example 6 had a diameter-to-height ratio of 5 and a through-hole occupying rate of 1.79%. The sensing fabric was tested by the step similar to step 5 of Example 1, and the data was collected and shown in Table 2 below.

### Example 7

A sensing fabric (Example 7) was prepared as described above in Example 1, except that step 1 described in Example 1 is replaced with the following step:

An elastic layer with a size of 19.0 cm (length)×19.0 cm (width)×0.13 mm (thickness) was cut by a laser cutting machine to form 58 circular holes with diameters of 10 mm in the elastic layer. The cavity of the sensing fabric in Example 7 had a diameter-to-height ratio of 76.9 and a through-hole occupying rate of 2.44%. The sensing fabric was tested by the step similar to step 5 of Example 1, and the data was collected and shown in Table 2 below.

TABLE 2

| | Cavity | Resistance | Resistance | Diameter- |
|---|---|---|---|---|
| | Rate | without Load | with | to-Height |
| Example | (%) | (Ω) | Load (Ω) | Ratio |
| 3 | 12.6 | 5079 | 786 | 50 |
| 4 | 12.6 | 15157 | 793 | 30.3 |
| 5 | 12.6 | 20584 | 1056 | 10 |
| 6 | 12.6 | 21678 | 1367 | 5 |
| 7 | 12.6 | 4063 | 806 | 76.9 |

As shown in Table 2, the cavity rates of the sensing fabrics in Examples 3-7 are fixed at 12.6%, and the factor that may affect the resistance of the sensing fabrics is the diameter-to-height ratio of the cavity. Referring to the data corresponding to Examples 3 and 7, the resistance of each sensing fabric may drop over 3,200Ω when applying the weight on the sensing fabric. Thus, the change in the resistance is high enough to be distinguished. In other words, the corresponding signals transmitted to computer terminals or monitors are also distinguishable. Referring to the data corresponding to Examples 4-6, the diameter-to-height ratio of the cavity in each sensing fabric is in a range of 5-30.3, and the resistance of each sensing fabric may drop over 14,000Ω when applying the weight on the sensing fabric. In other words, the change in the resistance of Examples 4-6 is much greater than that of Examples 3 and 7. Accordingly, the sensing fabrics of Examples 4-6 may be suitable for physiological sensors requiring high sensitivity.

### Example 8

A sensing fabric (Example 8) was prepared as described above in Example 1, except that step 1 described in Example 1 is replaced with the following step:

An elastic layer with a size of 2.3 cm (length)×2.3 cm (width)×0.3 mm (thickness) was cut by a laser cutting machine to form 1 circular hole with diameter of 10 mm in the elastic layer. The cavity of the sensing fabric in Example 8 had a cavity rate of 14.9%. The sensing fabric was tested by the step similar to step 5 of Example 1, and the data was collected and shown in Table 3 below.

### Example 9

A sensing fabric (Example 9) was prepared as described above in Example 1, except that the elastic layer described in step 1 of Example 1 was cut to form 2 circular holes with diameters of 10 mm in the elastic layer. The cavity of the sensing fabric in Example 9 had a cavity rate of 25.1%. The sensing fabric was tested by the step similar to step 5 of Example 1, and the data was collected and shown in Table 3 below.

### Example 10

A sensing fabric (Example 10) was prepared as described above in Example 1, except that step 1 described in Example 1 is replaced with the following step:

An elastic layer with a size of 2.7 cm (length)×2.7 cm (width)×0.3 mm (thickness) was cut by a laser cutting machine to form 3 circular holes with diameters of 10 mm in the elastic layer. The cavity of the sensing fabric in Example 10 had a cavity rate of 32.3%. The sensing fabric was tested by the step similar to step 5 of Example 1, and the data was collected and shown in Table 3 below.

### Example 11

A sensing fabric (Example 11) was prepared as described above in Example 1, except that the elastic layer described in step 1 of Example 1 was cut to form 3 circular holes with diameters of 10 mm in the elastic layer. The cavity of the sensing fabric in Example 11 had a cavity rate of 37.7%. The sensing fabric was tested by the step similar to step 5 of Example 1, and the data was collected and shown in Table 3 below.

### Example 12

A sensing fabric (Example 12) was prepared as described above in Example 1, except that step 1 described in Example 1 is replaced with the following step:

An elastic layer with a size of 2.2 cm (width)×3.6 cm (length)×0.3 mm (thickness) was cut by a laser cutting machine to form 6 circular holes with diameters of 10 mm in the elastic layer (the distance between centers of two adjacent circular holes is 11 mm). The cavity of the sensing fabric in Example 12 had a cavity rate of 59.5%. The sensing fabric was tested by the step similar to step 5 of Example 1, and the data was collected and shown in Table 3 below.

### Comparative Example 1

A sensing fabric (Comparative Example 1) was prepared as described above in Example 1, except that step 1 described in Example 1 is replaced with the following step:

An elastic layer with a size of 2.1 cm (width)×3.2 cm (length)×0.3 mm (thickness) was cut by a laser cutting machine to form 6 circular holes with diameters of 10 mm in the elastic layer (the distance between centers of two adjacent circular holes is 10.5 mm). The cavity of the sensing fabric in Comparative Example 1 had a cavity rate of 70.1%. The sensing fabric was tested by the step similar to step 5 of Example 1, and the data was collected and shown in Table 3 below.

### Comparative Example 2

A sensing fabric (Comparative Example 2) was prepared as described above in Example 1, except that step 1 described in Example 1 is replaced with the following step:

An elastic layer with a size of 4.0 cm (width)×4.4 cm (length)×0.3 mm (thickness) was cut by a laser cutting machine to form 1 circular hole with diameter of 10 mm in the elastic layer. The cavity of the sensing fabric in Comparative Example 2 had a cavity rate of 4.5%. The sensing fabric was tested by the step similar to step 5 of Example 1, and the data was collected and shown in Table 3 below.

### Comparative Example 3

A sensing fabric (Comparative Example 3) was prepared as described above in Example 1, except that step 1 described in Example 1 is replaced with the following step:

An elastic layer with a size of 8.5 cm (width)×9.2 cm (length)×0.3 mm (thickness) was cut by a laser cutting machine to form 1 circular hole with diameter of 10 mm in the elastic layer. The cavity of the sensing fabric in Comparative Example 3 had a cavity rate of 1.0%. The sensing fabric was tested by the step similar to step 5 of Example 1, and the data was collected and shown in Table 3 below.

TABLE 3

| | Cavity | Resistance | Resistance | Diameter- |
|---|---|---|---|---|
| | Rate | without | with | to-Height |
| Example | (%) | Load (Ω) | Load (Ω) | Ratio |
| 8 | 14.9 | 22335 | 961 | 33.3 |
| 9 | 25.1 | 21078 | 894 | 33.3 |
| 10 | 32.3 | 20096 | 721 | 33.3 |
| 11 | 37.7 | 18462 | 653 | 33.3 |
| 1 | 50.3 | 18215 | 483 | 33.3 |
| 12 | 59.5 | 2096 | 509 | 33.3 |
| comparative 1 | 70.1 | 684 | 645 | 33.3 |
| comparative 2 | 4.5 | 22657 | 14897 | 33.3 |
| comparative 3 | 1.0 | 23689 | 20561 | 33.3 |

The cavity rate of the sensing fabric (Comparative Example 1) is 70.1%. Since the cavity rate of the sensing fabric is relatively high (i.e. the proportion the elastic layer in the sensing fabric is relatively low), the first conductive textile layer may easily hang down on the second conductive textile layer even when there is no weight put atop the sensing fabric. As a result, the resistance of the sensing fabric is as low as 684Ω at this time, which is close to the resistance of the sensing fabric when the weight is put atop. In other words, there is no obvious change in the resistance before and after putting the weight on the sensing fabric if the cavity rate is too high. Therefore, the sensing fabrics provided in Comparative Example 1 may not be suitable for detecting the movement of the wearer effectively.

The cavity rates of the sensing fabrics (Comparative Examples 2 and 3) are less than 5%. When the weight is put on the sensing fabric, the resistance of each sensing fabric is still higher than 14,000Ω. The reason is that the cavity rate is too low to make the first conductive textile layer contact the second conductive textile layer even when the weight is put atop the sensing fabric. Therefore, the sensing fabrics provided in Comparative Examples 2 and 3 may not be suitable for detecting the movement of the wearer effectively.

### Example 13

A sensing fabric (Example 13) was prepared as described above in Example 1, except that steps 2 and 5 described in Example 1 were slightly modified. In detail, several through holes with diameters of 0.446 mm were fabricated in the first conductive textile layer in step 2. The through-hole occupying rate is 0.469%. Step 5 of Example 1 for measuring the resistance of the sensing fabric is modified as follows.

A solid foam with a size of 10 cm×10 cm×1 cm was put on a platform. Then, the sensing fabric obtained in step 4 was put on the solid foam, and the first conductive textile layer and the second conductive textile layer of the sensing fabric were respectively electrically connected to a positive and a negative electrode of a multimeter. Subsequently, the resistance of the sensing fabric was measured after a circular PMMA plate with a radius of 1 cm (2 g in weight) was put on the sensing fabric. Then, the resistance of the sensing fabric was measured again after a 800-gram weight was put on the center of the circular PMMA plate on the sensing fabric. Afterwards, removing the weight and waiting for 5 seconds, then the resistance of the sensing fabric was measured again. The data was collected and shown in Table 4.

### Example 14

A sensing fabric (Example 14) was prepared as described above in Example 13, except that step 2 described in Example 13 was slightly modified in a way that several through holes with diameters of 1.41 mm were fabricated in the first conductive textile layer. The through-hole occupying rate is 4.69%. The data was collected and shown in Table 4.

### Comparative Example 4

A sensing fabric (Comparative Example 4) was prepared as described above in Example 13, except that step 2 described in Example 13 was slightly modified in a way that several through holes with diameters of 0.316 mm were fabricated in the first conductive textile layer. The through-hole occupying rate is 0.236%. The data was collected and shown in Table 4.

TABLE 4

| | | | | | Through- |
|---|---|---|---|---|---|
| | | Resistance | | Resistance | Hole |
| | Cavity | without | Resistance | after | Occupying |
| | Rate | Load | with | Removing | Rate |
| Example | (%) | (Ω) | Load (Ω) | Load (Ω) | (%) |
| 1 | 50.3 | 18215 | 483 | 17548 | 2.36 |
| 13 | 50.3 | 10379 | 502 | 9812 | 0.469 |
| 14 | 50.3 | 23298 | 516 | 22354 | 4.69 |
| comparative 4 | 50.3 | 552 | 503 | 524 | 0.236 |

As shown in Table 4, for cases where the through-hole occupying rates are between 0.469% and 4.69%, the average difference in the resistance before and after putting the weight on the sensing fabrics is high enough to be distinguished even though the force is applied to the sensing fabrics several times. Thus, the sensing fabrics may be used to detect the movement of the wearer wearing the sensing fabrics.

For comparative example 4, the first conductive textile layer and the second conductive textile layer can be physically and electrically separated by the cavity when there is no weight put on the sensing fabric. When the weight is put on the sensing fabric, the resistance of the sensing fabric may drop to 503Ω because the first conductive textile layer is electrically connected to the second conductive textile layer. Afterwards, the resistance of the sensing fabric is measured again after the weight has been removed from the sensing fabric for 5 seconds. At this time, the resistance of the sensing fabric, however, is still as low as the resistance of the sensing fabric when the weight is put on. The reason is that the through-hole occupying rate of the sensing fabric is too low, and air outside the sensing fabric cannot fill into the cavity quickly after the removal of the weight. As a result, the space of the cavity cannot recover quickly, and the first conductive textile layer is still electrically connected to the second conductive textile layer even when the weight is removed. This obviously deteriorates the sensitivity of the sensing fabric.

### Bending Test

The resistance (R₀) of a sensing fabric (Example 1) was measured in a condition where the sensing fabric was put on a flat top surface of a table. Next, the sensing fabric was put on the edge of the table so that a half of the sensing fabric was still put on the flat top surface of the table, while the other half of the sensing fabric was protruded from the edge of the table and stretched tight to keep the entire sensing fabric level. Then, the protruding portion of the sensing fabric was bended at different angles, and the relationship between the resistance of the sensing fabric and the bending angles was measured. During the bending process, the resistance (R₁) of the sensing fabric might drop abruptly when the sensing fabric was bended at a certain bending angle, which was recorded in Table 5. Sensing fabrics (Examples 2-7) were also tested under the same procedure, and the results were shown in Table 5 below. In Table 5, R₀ represents the resistance of the sensing fabric at the beginning of the bending process, and R₁ represents the resistance of the sensing fabric with respect to a certain bending angle where resistance drops abruptly.

TABLE 5

| | | Bending | | |
|---|---|---|---|---|
| | | Angle where | | |
| | Cavity | Resistance | | Diameter- |
| | Rate | Drops | | to-Height |
| Example | (%) | Abruptly (°) | R₀/R₁ | Ratio |
| 1 | 50.3 | 30 | 19 | 33.3 |
| 2 | 50.3 | 40 | 28 | 20 |
| 3 | 12.6 | 20 | 12 | 50 |
| 4 | 12.6 | 32 | 21 | 30.3 |
| 5 | 12.6 | 50 | 20 | 10 |
| 6 | 12.6 | 60 | 16 | 5 |
| 7 | 12.6 | 10 | 5 | 76.9 |

As shown in Table 5, the resistance of the sensing fabrics (Examples 1-7) dropped abruptly (5≤R₀/R₁≤28) when each sensing fabric was bended at a certain angle. Therefore, when the sensing fabrics are put on the joints of a human body, data related to the movement of the joints (such as frequencies, angles and so forth) may be collected and measured effectively by the sensing fabrics.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A sensing fabric, comprising:
a first conductive textile layer;
a second conductive textile layer; and
an elastic layer, disposed between the first conductive textile layer and the second conductive textile layer, and at least a cavity is defined by the elastic layer, the first conductive textile layer, and the second conductive textile layer, wherein the first conductive textile layer is electrically connected to the second conductive textile layer by deforming and reducing a volume of the cavity,
wherein the cavity comprises at least a through hole and the trough hole is not disposed between two adjacent cavities so that the cavity may be exposed to an environment through the through hole.

2. The sensing fabric of claim 1, wherein a cavity rate in the sensing fabric is 10-60%.

3. The sensing fabric of claim 2, wherein a cavity rate in the sensing fabric is 12-55%.

4. The sensing fabric of claim 1, wherein a rate of an entire cross-sectional area of the through hole to an entire surface area of an inner sidewall of the cavity is 0.4-5%.

5. The sensing fabric of claim 1, wherein a rate of an entire cross-sectional area of the through hole to an entire surface area of an inner sidewall of the cavity is 0.45-5%.

6. The sensing fabric of claim 1, wherein a rate of an entire cross-sectional area of the through hole to an entire surface area of an inner sidewall of the cavity is 1.5-2.5%.

7. The sensing fabric of claim 1, wherein the height of the cavity is greater than 0.1 mm and less than or equal to 2 mm.

8. The sensing fabric of claim 7, wherein a diameter-to-height ratio of the cavity is 5-80.

9. The sensing fabric of claim 8, wherein a diameter-to-height ratio of the cavity is 5-35.

10. The sensing fabric of claim 1, wherein the first conductive textile layer or the second conductive textile layer comprises:
a fabric substrate; and
a conductive coating layer, comprising a hydrophobic adhesive and a plurality of conductive particles distributing therein, wherein the conductive coating layer is embedded in and leveled with a side of the fabric substrate, and a thickness of the conductive coating layer is not greater than a thickness of the fabric substrate.

11. The sensing fabric of claim 1, wherein the elastic layer comprises polyurethane, thermoplastic polyurethane, thermoplastic polyester elastomer, polyethylene, ethylene vinyl acetate, polyvinyl chloride, silicone or natural rubber.

12. The sensing fabric of claim 11, wherein the elastic layer is thermoplastic polyurethane.
